(19) United States
(12) Patent Application Publication
(10) Pub. No.: US 2022/0138844 A1
(43) Pub. Date: May 5, 2022

(54) METHODS AND SYSTEMS FOR RENDERING ACCESS TO FUNDS IN REAL TIME FROM A DEPOSIT

(71) Applicant: Huntington Bancshares Incorporated, Columbus, OH (US)

(72) Inventors: Bryan James Carson, New Albany, OH (US); Mark Richard Rhoades, Columbus, OH (US); Stephen Robert Hiddleston, Galena, OH (US)

(21) Appl. No.: 17/166,877

(22) Filed: Feb. 3, 2021

Related U.S. Application Data
(60) Provisional application No. 63/108,705, filed on Nov. 2, 2020.

(51) Int. Cl. G06Q 40/02; G06Q 20/40; G06Q 20/32; G06Q 20/02; G06Q 20/10; G06Q 50/26; G06F 16/245

(52) U.S. Cl. CPC G06Q 40/025; G06Q 20/4016; G06Q 20/405; G06Q 20/4037; G06F 16/245; G06Q 20/023; G06Q 20/1085; G06Q 50/265; G06Q 20/326

(57) ABSTRACT

A method performed by a server executing an algorithm to render access to funds in real time from one or more deposits, which the funds may be withdrawn from user's opened account. The method including the steps of evaluating user's banking relationship for eligibility in a financial institution, performing a real time fraud review on the real time deposit by directly querying a fraud database to clear a likelihood of fraudulent transaction for insufficient funds and verifying payer's legitimacy, determining an approved amount (or a percentage) of the deposits available for real time access based on decisioning criteria and user's deposit balance in the opened account. Once cleared, the user may access funds in real time from the deposit up to the daily approved limit, without being levied a service charge or interests on the withdrawn amount.

### CROSS-REFERENCE

The present application claims the benefit of priority under 35 U.S.C. § 119 from U.S. Provisional Patent Application Ser. No. 63/108,705 entitled “METHODS AND SYSTEMS FOR RENDERING ACCESS TO FUNDS IN REAL TIME FROM A DEPOSIT,” filed on Nov. 2, 2020, the disclosure of which is hereby incorporated by reference in its entirety for all purposes.

### TECHNICAL FIELD

The present disclosure generally relates to financial management systems and loan products and services, and more specifically relates to methods and systems for rendering funds in real time from a deposit.

### BACKGROUND

Customers who may face financial hardship and devastation may need real time or immediate access to one or more deposits (via paper checks, online deposits or electronic payments) for financial relief and help from, for example, their financial institutions. Such relief, however, may not be available from their financial institutions or may otherwise be subject to a delay (wait for hours to days to clear), or available at a certain cost (e.g., payment of service charge) that further reduces a net amount of the one or more deposits from which they may receive.

### BRIEF DESCRIPTION OF DRAWINGS

The disclosure is better understood with reference to the following drawings and description. The elements in the figures are not necessarily to scale, emphasis are instead being placed upon illustrating the principles of the disclosure. Moreover, in the figures, like-referenced numerals may designate to corresponding parts throughout the different views.

FIG. 1 illustrates an example of a computer implemented method of rendering access to funds in real time from one or more deposits made by an eligible customer.

FIG. 2 illustrates an example of a screenshot of a mobile application which renders access to funds in real time from one or more deposits made by an eligible customer.

### SUMMARY

In an example, the disclosure may describe a computer implemented method of rendering access to funds in real time from one or more deposits, which may be performed by at least a processor in a server and at least one code stored in a non-transitory computer-readable medium which causes the server to perform steps, including: evaluating in a database, user's bank relationship with a financial institution which the user has at least one opened checking account with one or more deposit activities for at least a defined minimum number of statement cycles, and having maintained an average daily balance above a defined amount as a portion of decisioning criteria. The server may perform a real time fraud review on the one or more deposit. In some aspects, the real time fraud review may include: matching a name of an issuer of the one or more deposit and an account number of the one or more deposit to a fraud database to determine one or more deposit legitimacy, and a likelihood of fraudulent transactions or insufficient funds. Once cleared of the fraud review, the server may determine an approved amount for real time fund access limit from one or more deposit per day, wherein the approved amount is based on one of: a fixed approved amount or a defined percentage of an average daily balance in a certain statement period. The server may then enable a user device through a mobile banking application or through on-line banking, granting real time fund access towards the one or more deposit to be drawn from the at least one opened checking account, wherein the real time fund access may be available from the one or more deposit up to the approved amount per day, wherein the real time fund access to the one or more deposit is without a service charge and without interests charged by the financial institution, while a remaining un-advanced amount of the one or more deposit may be directly deposited into the user's at least one opened checking account through usual funds clearance time frame.

Likewise, the disclosure may describe a non-transitory computer-readable medium which stores at least one code, when executed by at least a processor in a computer, causes the computer to render access to funds in real time from one or more deposit by performing the steps using the same method as mentioned above.

### DETAILED DESCRIPTION

Where it is appropriate throughout the description, the term “one or more deposit” may be interpreted as a single deposit or a plurality of deposits at the same time or at different times of the day, and the terms “real time access to deposit” and “real time access to deposit funds,” the terms “computer” and “server”, the terms “bank” and “financial institution” or the terms “user” and “customer”, may be used interchangeably respectively, without limitation.

In one or more implementations, not all of the depicted components in each figure may be required, and one or more implementations may include additional steps or components not shown in a figure. Variations in the arrangement and type of the components may be made without departing from the scope of the subject disclosure. Additional steps, components, different steps or components, fewer steps or components may also be utilized or modified within the scope of the subject disclosure.

A financial product, such as real time access to funds from one or more deposit, renders financial hardship relief to some customers of a financial institution. More specifically, the disclosure of this financial product, may be offered to its customers to provide real time access to one or more deposit funds based on decisioning criteria that may meet a long felt need of banking customers.

The decisioning criteria may include a customer's checking relationship with the financial institution, such as establishing a minimum number of statement cycles or having a minimum of two month's history of having an account opened, and subjecting each real time one or more deposit to a real time fraud review process by the financial institution to review the legitimacy on the source (payer) and sufficiency of one or more deposits. The decisioning criteria may be applied in combination with reviewing customer's credit history, existing collateral, such as current account balance and average account balance, history or frequency of overdrafts, and both total and average amount of one or more deposits, etc. In addition, the financial institution may determine and approve a maximum amount of real time access for a single total deposit or multiple deposits per day based on the above decisioning criteria.

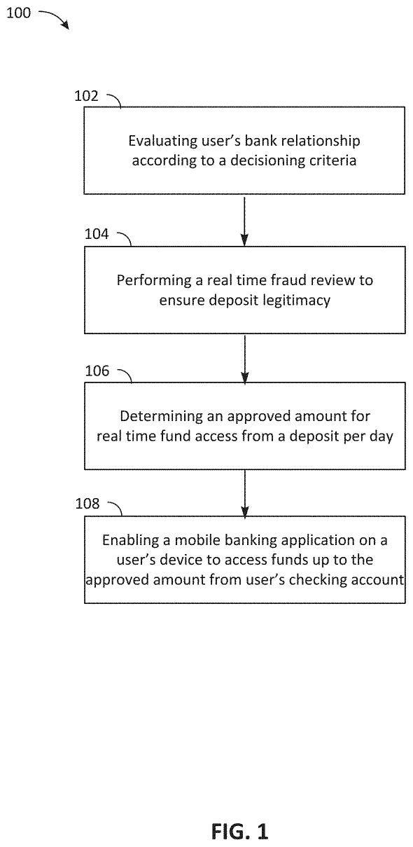

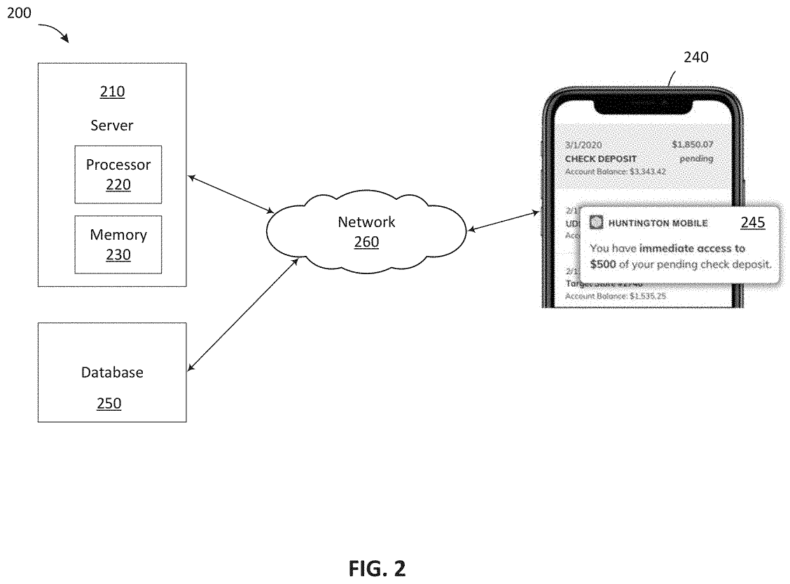

FIG. 1 illustrates an example of a computer implemented method 100 of rendering access to funds in real time from one or more deposits made by an eligible user (customer). In an embodiment, the method may be performed by a server (such as server 210 in FIG. 2) or by distributed processing in a cluster of computers (e.g., cloud computing). In implementation, the server 210 may include at least a processor 220 and a memory 230 (non-transitory computer-readable medium) which stores program code (algorithm), when being executed by the processor 220, the program code may cause the server 210 to perform steps in FIG. 1 which renders real time access to funds from one or more deposit through a banking application 245 installed on a user device 240.

In step 102, the server 210 may communicate with a database 250 through a network 260 to access user's bank relationship data with a financial institution to determine user's eligibility for real time access to funds from one or more deposit and a determination of an approved amount (or a percentage) of an entire deposit based on decisioning criteria and user's bank relationship data.

At a minimum, the decision criteria requires that the user has at least one opened checking account with recurring deposits made at the financial institution in order to qualify for the real time access to one or more deposit. The decisioning criteria may evaluate a recurring deposit amount, a periodicity (i.e., weekly, biweekly, semi-monthly, monthly, etc.) of the at least one recurring deposit, and an average monthly or current account balance as a collateral. Other decisioning criteria for the eligibility may also include user's credit history, overdraft history or frequency (if any) over a defined period of time such as at least three statement cycles. In other embodiments, customers can be auto-enrolled into the real time access to deposit funds program.

Although eligibility may be determined by the customer's checking account and relationship account activity, benefits of the real time access may be transparent to the customer through product disclosures. Nevertheless the moment when a customer is no longer eligible (i.e., low deposit balance, excessive overdrafts, etc.) the product may reduce the approved amount or altogether may be removed as an option from online and mobile banking.

In step 104, the server 210 may perform a real time fraud review on the one or more deposit to ensure deposit legitimacy. Various forms of fraud reviews exist. For example, the real time fraud review may include matching a name of an issuer (i.e., payer) of the one or more deposit and an account number of the one or more deposit of the issuer to a fraud database to determine deposit legitimacy or a likelihood of fraudulent transactions or checking for insufficient funds.

Once cleared of the fraud review, in step 106, an approved fixed amount (such as $500) or a specified percentage (such as up to 40%) of the entire deposit may be available to the user for immediate spending. In an embodiment, the approved fixed amount may be a maximum limit per day for the real time access to the deposit funds, even when multiple separate deposits are made at different times of the same day. That is, the $500 real time deposit access limit per day may apply to a single deposit of a single check, a single deposit of multiple checks, or multiple deposits of different individual checks at different times on the same day. In other words, once the $500 real time deposit access limit per day is reached, no further access may be permitted to the deposit funds from other checks or from subsequent deposits on the same day. Of course, the user may prefer to make subsequent deposits on a next day for real time access up to the daily maximum access limit, once the daily maximum access limit is reached for the day.

The one or more deposits may be made in person at a bank teller or at an ATM (automatic teller machine), and a remaining balance of the one or more deposit may clear through normal bank funds transfer process which may take from one to three days to clear. In another example, the one or more deposit may be made through an online check deposit (i.e., imaging through a bank mobile application), or through online electronic transfer deposit through anyone of: Zelle®, Quickpay®, Vemo®, Apple Pay®, Paypal®, etc. A remaining amount of the online deposit may clear after a few hours to two days depending on the amount, whether the transfer is from a different financial institution or whether the one or more deposit is from a recurring deposit. In other instances, the online electronic transfer deposit may be made accessible immediately

In another example, the approved real time deposit access amount may be higher than $500, such as up to $1,000 per day or up to a certain percentage of the total amount of one or more deposit, depending on the customer's banking relationship, or whether the user maintains a current balance sufficient to be used as a collateral for the real time access to the deposit. In certain cases, if a hold is required for the at least one deposit, real time access to the deposit funds may be prevented. An alert may be sent to the user to notify the user when the funds may become available. Alternately, a decision may be shared with the user for a reduced access amount in real time.

The server 210 may grant real time fund access up to the approved amount per day towards the one or more deposit available for immediate withdrawal from the at least one opened checking account. A text message may be pushed to the user device 240 to notify the user of an immediate access to the approved amount, which the approved amount accessed by the user is without a service charge (0%), without Advance Fee, and 0% APR interest would be charged by the financial institution. Of course, the financial institution may retain the right to charge some type of fee or interest is charged subject to advance notification to the user.

In implementation, the real time fraud review may include the server 210 performing, in real time without going through a third party, one or more of: querying a risk assessment database 240 for names of suspicious issuers or organizations, checking for sanction lists or terrorist organizations, checking for country on funds origin, international banking SWIFT codes, routing numbers, bank account numbers. Other fraud review may include checking statistics of user's overdraft history and un-honored deposits history. In another example, the server may have an in-house decision logic algorithm specific to the rules of the financial institution which may allow a one-time access up to 80% of the total deposit amount on the at least one deposit, or may allow a daily maximum of up to $2,000 for immediate access from the one or more deposit.

In another example, the real time fraud review may include the server 210 performing making a real time fraud call directly to a Deposit Fraud Prevention tool (SAS Fraud Manager) to obtain a real-time fraud decision such as auto-hold, review or pass across deposits made at an Automatic Teller Machine (ATM) or a Mobile & Teller to evaluate risks through a determination of a rate on line (ROL), which is a premium paid to obtain reinsurance against loss or risk.

In step 108, the mobile banking application 245 installed on the user's device 240 may be enabled to access the approved amount or the specified percentage of the entire deposit (for example, a paycheck). An updated current balance in the user's at least one opened checking account may be shown after the one or more deposits, while any balance of the remainder may be shown after clearance of the one or more deposits in the user's at least one opened checking account.

In certain cases, if the funds in the at least one deposits fail to clear (i.e., risk or loss) in the at least one opened checking account of the user after the usual funds clearance time frame, the server 210 may be configured to recover a portion of or up to an entire amount of a withdrawn amount of real time accessed funds from the user's at least one opened checking account in a current or a subsequent statement period.

Various aspects of the disclosure have been described above. While the present invention has been described with reference to certain embodiments, it will be understood by those skilled in the art that various changes may be made and equivalents may be substituted without departing from the scope of the present invention, such as reordering of the sequence of steps in the method disclosed. In addition, many modifications may be made to adapt a particular situation or material to the teachings of the present invention without departing from its scope. Accordingly, various claimed subject matter have been described herein and by the appended claims without limiting the scope of the claimed subject matter.

What is claimed is:

1. A computer implemented method of rendering access to funds in real time from one or more deposits, comprising executing by at least a processor in a server, at least one code stored in a non-transitory computer-readable medium which causes the server to perform steps, comprising:
evaluating in a database, user's bank relationship with a financial institution which the user has at least one opened checking account with one or more deposits activities for at least a defined minimum number of statement cycles and having maintained an average daily balance above a defined amount as a portion of decisioning criteria;
performing a real time fraud review by the financial institution on the one or more deposits;
determining an approved amount per day, as real time fund access limit from one or more deposits, wherein the approved amount is based on one of: a fixed approved amount or a defined percentage of an average daily balance in a certain statement period;
once the approved amount has been determined, granting real time fund access up to the approved amount per day towards the one or more deposits available for immediate withdrawal from the at least one opened checking account, without a service charge and without interests charged by the financial institution; and
directly depositing into the user's at least one opened checking account, remaining un-advanced amount of the one or more deposits through usual funds clearance time frame.

2. The computer implemented method of claim 1, wherein the decisioning criteria comprises: evaluating the user's credit history, a history or frequency of overdrawn, and a current account balance as a collateral.

3. The computer implemented method of claim 1, wherein the approved amount for the real time access from the one or more deposits up to 40% of entire deposit but not to exceed $500 per customer per day in the total real time access.

4. The computer implemented method of claim 1, wherein the one or more deposits being one of: one or more deposits made in person at a bank teller, at an ATM (Automatic Teller Machine), ACH (Automatic Clearing House) wiring, online check deposit through a bank mobile application, and online direct electronic deposit comprising at least anyone of: Zelle®, Quickpay®, Vemo®, Apple Pay®, Paypal®.

5. The computer implemented method of claim 4, wherein the rendering access to funds in real time from one or more deposits further comprising decision sharing with the user and sending alerts to the user when check deposit funds become available, when a hold is placed and when a hold is released.

6. The computer implemented method of claim 1, wherein the real time fraud review by the financial institution on the one or more deposits comprising performing in real time, matching a name of an issuer or payer of the one or more deposits and an account number of the one or more deposits to a fraud database to determine deposit legitimacy or a likelihood of fraudulent transactions or insufficient funds.

7. The computer implemented method of claim 6, wherein the real time fraud review is performed using an in-house decision logic algorithm by the financial institution to allow up to 80% of the at least one deposits or a daily maximum of up to $2,000 is available for immediate access from the one or more deposits.

8. The computer implemented method of claim 6, wherein the real time fraud review by the financial institution on the one or more deposits further comprising one or more of: querying a risk assessment database to query for names of suspicious issuers or organizations, checking for sanction lists or terrorist organizations, country of source of fund, international banking SWIFT codes, routing numbers, bank account numbers, and statistics of user's overdraft history and history of un-honored deposits at the financial institution.

9. The computer implemented method of claim 8, wherein the real time fraud review by the financial institution on the one or more deposits further comprising evaluating risks through a rate on line (ROL) determination.

10. The computer implemented method of claim 9, further comprising in case if the funds in the one or more deposits fails to clear in the at least one opened checking account of the user after the usual funds clearance time frame, recovering by the server, a portion of or up to an entire amount of a withdrawn amount of real time accessed funds from the user's at least one opened checking account in a current or subsequent statement period.

11. A non-transitory computer-readable medium which stores at least one code, when executed by at least a processor in a computer, causes the computer to render early access to funds in real time from one or more deposits by performing steps, comprising:
evaluating in a database, user's bank relationship with a financial institution which the user has at least one opened checking account with one or more deposits activities for at least a defined minimum number of statement cycles and having maintained an average daily balance above a defined amount as a portion of decisioning criteria;
performing a real time fraud review by the financial institution on the one or more deposits;
determining an approved amount per day, as real time fund access limit from one or more deposits, wherein the approved amount is based on one of: a fixed approved amount or a defined percentage of an average daily balance in a certain statement period;
once the approved amount is determined, granting real time fund access up to the approved amount per day towards the one or more deposits available for immediate withdrawal from the at least one opened checking account, without a service charge and without interests charged by the financial institution; and
directly depositing into the user's at least one opened checking account, remaining un-advanced amount of the one or more deposits through usual funds clearance time frame.

12. The non-transitory computer-readable medium of claim 11, wherein the decisioning criteria comprises: evaluating the user's credit history, a history or frequency of overdrawn, and a current account balance as a collateral.

13. The non-transitory computer-readable medium of claim 11, wherein the approved amount for the real time access from the one or more deposits up to 40% of entire deposit but not to exceed $500 per customer per day in the total real time access.

14. The non-transitory computer-readable medium of claim 11, wherein the one or more deposits being one of: one or more deposits made in person at a bank teller, at an ATM (Automatic Teller Machine), ACH (Automatic Clearing House) wiring, online check deposit through a bank mobile application, and online direct electronic deposit comprising at least anyone of: Zelle®, Quickpay®, Vemo®, Apple Pay®, Paypal®.

15. The non-transitory computer-readable medium of claim 14, wherein the rendering access to funds in real time from the one or more deposits further comprising decision sharing with the user and sending alerts to the user when check deposit funds become available, when a hold is placed and when a hold is released.

16. The non-transitory computer-readable medium of claim 11, wherein the real time fraud review by the financial institution on the one or more deposits comprising performing in real time, matching a name of an issuer or payer of the one or more deposits and an account number of the one or more deposits to a fraud database to determine deposit legitimacy or a likelihood of fraudulent transactions or insufficient funds.

17. The non-transitory computer-readable medium of claim 16, wherein the real time fraud review is performed using an in-house decision logic algorithm by the financial institution to allow up to 80% of the one or more deposits or a daily maximum of up to $2,000 is available for immediate access from the one or more deposits.

18. The non-transitory computer-readable medium of claim 16, wherein the real time fraud review by the financial institution on the one or more deposits further comprising one or more of: querying a risk assessment database to query for names of suspicious issuers or organizations, checking for sanction lists or terrorist organizations, country of source of fund, international banking SWIFT codes, routing numbers, bank account numbers, and statistics of user's overdraft history and history of un-honored deposits at the financial institution.

19. The non-transitory computer-readable medium of claim 18, wherein the real time fraud review by the financial institution on the one or more deposits further comprising evaluating risks through a rate on line (ROL) determination.

20. The non-transitory computer-readable medium of claim 19, further comprising in case if the funds in the at least one deposits fails to clear in the at least one opened checking account of the user after the usual funds clearance time frame, recovering by the server, a portion of or up to an entire amount of a withdrawn amount of real time accessed funds from the user's at least one opened checking account in a current or subsequent statement period.
